(19) United States
(12) Patent Application Publication
(10) Pub. No.: US 2010/0326165 A1
(43) Pub. Date: Dec. 30, 2010

(54) DETECTOR TEST DEVICE

(75) Inventors: Timothy A. Rauworth, West Chicago, IL (US); Dale H. Johnson, Elgin, IL (US)

Correspondence Address: HONEYWELL/HUSCH;Patent Services, 101 Columbia Road, P.O.Box 2245, Morrlstown, NJ, 07962, US

(73) Assignee: HONEYWELL INTERNATIONAL INC., Morristown, NJ (US)

(21) Appl. No.: 12/491,679

(22) Filed: Jun. 25, 2009

(51) Int. Cl. G01D 18/00

(52) U.S. Cl. 73/1.06

(57) ABSTRACT

A gas detector test device includes a housing which can receive the detector to be tested, at least in part. A reference gas detector is carried by the housing. The reference detector is in wireless communication with the detector under test. A gas sample can be injected into the housing. Both detectors can respond to the sample and the detector under test can communicate sensitivity indicia to the reference detector for comparison. Visual, or audible indicia can be generated, indicative of the results of the comparison.

### FIELD

The invention pertains to devices which can be used to evaluate the sensitivity of gas or ambient condition detectors. More particularly, the invention pertains to such devices which can wirelessly communicate with the subject detector and provide audible or visual feedback as to sensitivity of that detector.

### BACKGROUND

There are times when it is desirable to measure the sensitivity of one or more gas detectors. Currently, sensitivity testing requires that gas detectors be exposed to a known concentration gas, and time to alarm be recorded. This is time consuming, expensive, and prone to errors when done by an installer or service person. There are also times when it is useful to measure the sensitivity of smoke detectors.

### BRIEF DESCRIPTION OF THE DRAWINGS

FIG. 1 is a block diagram of a gas detector coupled to a test device which embodies the invention; and

FIG. 2 is a block diagram illustrating various aspects of the test device of FIG. 1.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect, a device which embodies the invention includes an integrated reference gas detector. Circuitry associated with that detector can wirelessly communicate with the gas detector being tested. Parameters of the gas detector being tested, such as sensitivity or calibration, can be established independent of applied gas concentration.

The test device can include a reference detector that is both calibrated to known accuracy, and which can communicate with the gas detector being tested through a wireless interface for example via an optical or RF transmitter or transceiver.

The test device forms a seal against the detector being tested so that a reference detector and the UUT (Unit under test) are measuring the same concentration of gas. A small quantity of test gas is injected into a test chamber preferably located between the reference detector and the unit under test.

The concentration of the test gas injected into the chamber need only be high enough to register, and not so high that it saturates either detector. The reference detector measures the concentration and compares it to the concentration read by the UUT. The results of the comparison can be output on indicators, either numerically, or by go/no-go lights. Alternately, the test device can wirelessly communicate test results to an operator's portable or hand-held unit. The test unit may further communicate with the UUT to initiate a speedup mode to facilitate a faster test.

Embodiments of the invention can be used to evaluate surface mounted, portable or wearable gas detectors. Alternately, sensitivity parameters of various types of smoke detectors, or other types of detectors, can be evaluated. In yet another aspect of the invention, the hand held unit can communicate not only with the test device but also with an associated regional monitoring system.

The test device can incorporate a gas inflow valve controlled by local control circuitry. Such circuitry can be implemented, as part of the reference or calibration detector, by a programmable processor and control programs locally stored on a computer readable storage medium.

In yet another aspect of the invention, a gas source can be releasibly coupled to a gas inflow port of the test device. Alternately, the gas source can be formed integral with the test device.

In yet another aspect of the invention, a solid state source of gas can be carried by the test device as an alternate to using a source of gas and an associated valve. Further, the test device can respond to the detector under test emitting an audible or visual indicator in response to being exposed to the test gas.

In a further aspect of the invention, the test unit can transmit a command to the detector under test to adjust its sensitivity in accordance with a sensitivity being measured by the test unit.

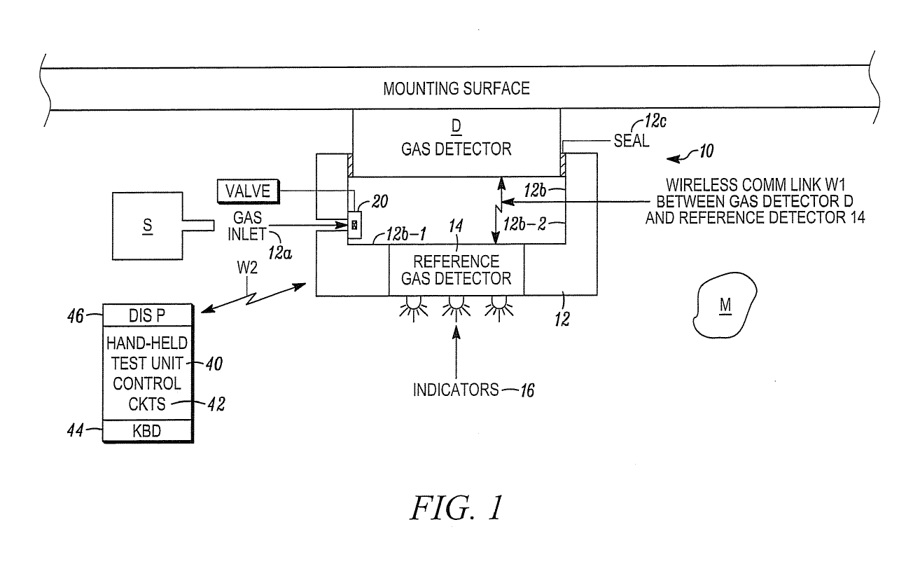

FIG. 1 illustrates a test unit 10 of the present invention coupled to an exemplary gas detector D (would could be mounted to a surface, wearable or portable all without limitation). Unit 10 is releasibly coupled to detector D. Alternately, the detector under test could be completely contained within the unit 10.

The unit 10, as illustrated in FIG. 1 includes a housing 12 which carries a reference gas detector 14. The reference detector of unit 10 is intended to sense the same type of condition as the detector D under test.

The housing 12 includes a gas inlet, or inflow port, 12a. The housing 12 defines an interior region 12b formed in part by an end wall 12b-1 and a bounding side wall 12b-2. The region 12b is closed by the detector D under test. A seal 12c could be provided, on housing 12 between housing 12 and the detector under test D.

One or more visual indicators 16 can be carried by the detector 14 to indicate test results. It will also be understood that audible indicators could also be provided without departing from the spirit and scope of the invention.

A source S of test fluid, gas or smoke for example, could be coupled to the inlet 12a. Source S can be releasibly coupled to housing 12 or formed integral therewith. A valve 20, carried on the source S or by housing 12 can be controlled by the reference detector 14 to inject a test sample of the selected fluid into the region 12b.

Both the detector under test D and the reference detector 14 respond to the injected sample. The detector 14 can wirelessly obtain, via wireless communication link W1, for example, an optical link or an RF link, information or parameters from detector D as to how detector D has responded to the injected sample. The audible or visual indicators 16 can be activated to advise an adjacent maintenance personnel as to the results of the test, for example the sensitivity of detector D to the injected sample. Other information as to the response of detector D to the sample can also be reported via indictors 16, or via hand held wireless test and control unit 40, discussed subsequently.

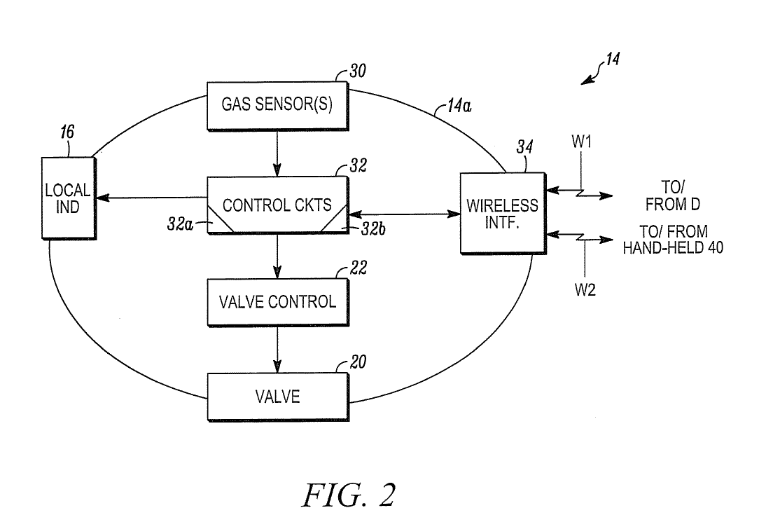

FIG. 2 illustrates exemplary details of reference detector 14. Detector 14 can include one or more gas sensors, indicated at 30, local control circuits 32 coupled to the sensors 30 to receive electrical signals therefrom indicative of sensed fluids.

The control circuits 32 can be implemented in part by a programmable processor 32a and associated control software 32b. The software 32b can be locally stored on a computer readable storage medium and in combination with processor 32a can implement previously discussed functions of detector 14.

Detector 14 can also include a wireless interface 34 which can communicate via medium W1 with the detector D under test. Alternately, or in addition, interface 34 can communicate with wireless test and control unit 40 which might be carried by maintenance personnel using the unit 10 to test detector D.

Hand held unit 40 can include control circuits and transceiver 42 to communicate with detector 14. Handheld unit 40 can also include a keyboard 44 to input commands to reference detector 14 and a display 46, both coupled to control circuits and transceiver 42. Keyboard 44 and display 46 enable the operator to both control on-going tests as well as to graphically receive results via display 46. The unit 40 could also be in wireless communication with a regional monitoring system M to which detector D is coupled.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A unit to calibrate a detector comprising:
a housing which has a detector receiving region;
a reference sensor carried on the housing where the reference sensor can wirelessly communicate with a detector being tested; and
a calibration fluid inflow port, carried by the housing where the calibrating fluid can be injected into the internal region.

2. A unit as in claim 1 which includes a valve carried on the housing, the valve at least intermittently, opens the inflow port.

3. A unit as in claim 2 which includes control circuits coupled to the sensor and the valve.

4. A unit as in claim 1 which includes concentration evaluation circuitry coupled to the sensor with the sensor and circuitry in combination responsive to at least one selected fluid in the internal region to establish a sensitivity parameter associated therewith.

5. A unit as in claim 4 where the reference sensor comprises one of a gas sensor or a smoke sensor, and the fluid comprises one of a selected gas or, smoke.

6. A unit as in claim 5 which includes a valve carried on the housing, the valve at least intermittently, opens the inflow port.

7. A unit as in claim 6 where the circuitry is coupled to the valve.

8. A unit as in claim 3 which includes a wireless interface.

9. A unit as in claim 8 where the wireless interface comprises at least one of an optical-type transmitting interface or a radio-type transmitting interface.

10. A unit as in claim 9 which includes a second, different transmitter, and a remote, portable test and control apparatus in communication with the second transmitter.

11. A unit as in claim 10 where the portable test and control apparatus includes a visual display and a manually operable data entry element.

12. A unit as in claim 8 where the housing has a bounding sidewall and a closed end which define, in part, the internal region.

13. A unit as in claim 12 where the detector receiving region is displaced from the closed end and the reference sensor is displaced from the detector receiving region.

14. A unit to calibrate a detector comprising:
a housing, the housing has a bounding sidewall and a closed end which define, in part, an internal region where the side wall has a detector receiving region displaced from the closed end;
a reference sensor carried on the housing, at the closed end where the reference sensor can wirelessly communicate with a detector being tested;
a wireless interface coupled to the sensor; and
a source of calibrating fluid which is one of, carried by the housing where the calibrating fluid can be injected into the internal region, or generated by a source carried by the housing.

15. A unit as in claim 14 which includes a valve carried on the housing, the valve at least intermittently, opens an inflow port.

16. A unit as in claim 15 which includes control circuits coupled to the sensor, the wireless interface and the valve.

17. A unit as in claim 16 where the control circuits include concentration evaluation circuitry coupled to the sensor with the sensor and the evaluation circuitry in combination responsive to at least one selected fluid in the internal region to establish a sensitivity parameter associated therewith.

18. A unit as in claim 17 which includes a test fluid source, the source is one of, integral with the housing, releasibly coupled thereto, or, a solid state generator.

19. A unit as in claim 14 which can communicate a command to the detector which would cause that detector to adjust a sensitivity parameter thereof in accordance with a sensitivity parameter that the unit is measuring.

20. A unit as in claim 14 where the wireless interface comprises one of an audible receiver, an optical receiver, or a radio frequency receiver.
